(19) United States
(12) Patent Application Publication
(10) Pub. No.: US 2006/0284793 A1
(43) Pub. Date: Dec. 21, 2006

(54) Display system using mobile communication terminal, method of displaying image, and computer program product

(76) Inventors: Young-soo Park, Suwon-si (KR); Jung-woo Kim, Yongin-si (KR); Jang-yeon Kwon, Seongnam-si (KR); In-kyeong Yoo, Suwon-Si (KR)

Correspondence Address: CANTOR COLBURN, LLP, 55 GRIFFIN ROAD SOUTH, BLOOMFIELD, CT, 06002, US

(21) Appl. No.: 11/453,537

(22) Filed: Jun. 15, 2006

(30) Foreign Application Priority Data
Jun. 18, 2005 (KR) 10-2005-0052724

(51) Int. Cl. G09G 3/20

(52) U.S. Cl. 345/55; 345/82

(57) ABSTRACT

Provided is a display system that uses a mobile communication terminal. The display system includes a mobile communication terminal having an insertion unit, and a mobile display device having a slot-type connection unit insertable into the insertion unit of the mobile communication terminal. Accordingly, it is possible to display received content on a display screen larger than that of the mobile communication terminal. Also, the display system overcomes noise problems and displays high-definition images by constructing a minimum number of connection terminals that connect the mobile display device to the mobile communication terminal. A method for displaying an image from a mobile communication terminal and a computer program product including a storage medium for performing the method are also provided.

This application claims priority to Korean Patent Application No. 10-2005-0052724, filed on Jun. 18, 2005 and all the benefits accruing therefrom under 35 U.S.C. §119, and the contents of which in its entirety are herein incorporated by reference.

### BACKGROUND OF THE INVENTION

1. Field of the Invention

The present invention relates to a display system that uses a mobile communication terminal, a method of displaying an image, and a computer program product. More particularly, the present invention relates to a display system that uses a mobile communication terminal, which is capable of displaying high-definition images using a display device, a method of displaying an image using the display system, and a computer program product having a storage medium for performing the method.

2. Description of the Related Art

In recent years, various services have been provided using mobile communication terminals. Much attention has recently been paid to digital multimedia broadcasting (“DMB”) which is one of the various services. DMB services, which are next-generation mobile multimedia broadcasting services that combine broadcasting and communications, can be classified into terrestrial DMB services and satellite DMB services according to methods of transmission and network construction.

However, video display according to the DMB services or the other services is limited in terms of the size of a display screen on the mobile communication terminal. That is, there is a limitation to increasing the size of the display screens of mobile communication terminals in terms of portability. In the mean time, when an image provided from a DMB service is displayed on a small display screen of a mobile communication terminal, a user of the mobile communication terminal has difficulties in viewing the displayed image.

### BRIEF SUMMARY OF THE INVENTION

Embodiments of the present invention provide a display system that uses a mobile communication terminal in which high-definition images are displayed on a larger screen than that of the mobile communication terminal by using a display device with a slot-type connection terminal to be connected to the mobile communication terminal.

According to exemplary embodiments of the present invention, there is provided a display system that uses a mobile communication terminal, the display system including a mobile communication terminal having an insertion unit, and a mobile display device having a slot-type connection unit insertable into the insertion unit of the mobile communication terminal.

According to other exemplary embodiments of the present invention, there is provided a method of displaying an image from a mobile communication terminal, the method including transmitting image data from the mobile communication terminal to a mobile display device, and displaying the image on a display panel of the mobile display device.

According to other exemplary embodiments of the present invention, there is provided a computer program product for displaying an image from a mobile communication terminal, the computer program product including a storage medium readable by a processing circuit and storing instructions for execution by the processing circuit for performing a method including transmitting image data from the mobile communication terminal to a mobile display device, and displaying the image on a display panel of the mobile display device.

### BRIEF DESCRIPTION OF THE DRAWINGS

The above and other aspects and advantages of the present invention will become more apparent by describing in detail exemplary embodiments thereof with reference to the attached drawings in which:

FIG. 1 is a block diagram illustrating an exemplary embodiment of a display system using a mobile communication terminal according to the present invention;

FIGS. 2A and 2B illustrate exemplary embodiments of mobile display devices matching exemplary types of mobile communication terminals, according to the present invention;

FIG. 3 is a perspective view of an exemplary mobile display device of an exemplary embodiment of a display system that uses a mobile communication terminal, according to the present invention; and

FIG. 4 illustrates signal exchange between a mobile communication terminal and an exemplary embodiment of a mobile display device according to the present invention.

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, exemplary embodiments of a display system using a mobile communication terminal according to the present invention will be described in detail with reference to the accompanying drawings.

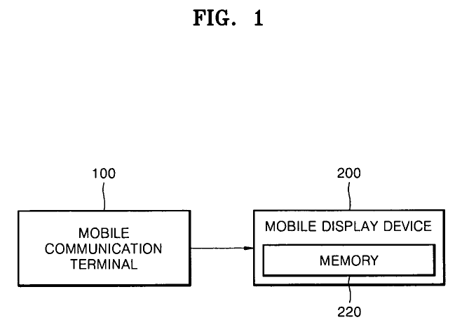

FIG. 1 is a block diagram illustrating an exemplary embodiment of a display system using a mobile communication terminal 100. Referring to FIG. 1, the display system includes the mobile communication terminal 100 and a mobile display device 200.

The mobile communication terminal 100 includes an insertion unit (not shown) via which the mobile communication terminal 100 is connected to an external device. The mobile communication terminal 100 may be, but is not limited to, a mobile phone, a personal digital assistant (“PDA”), a digital multimedia broadcasting (“DMB”) terminal, an MPEG audio layer 3 (“MP3”) player, etc. The DMB terminal may be manufactured as an integrated terminal that includes the functions of a satellite DMB terminal and a terrestrial DMB terminal.

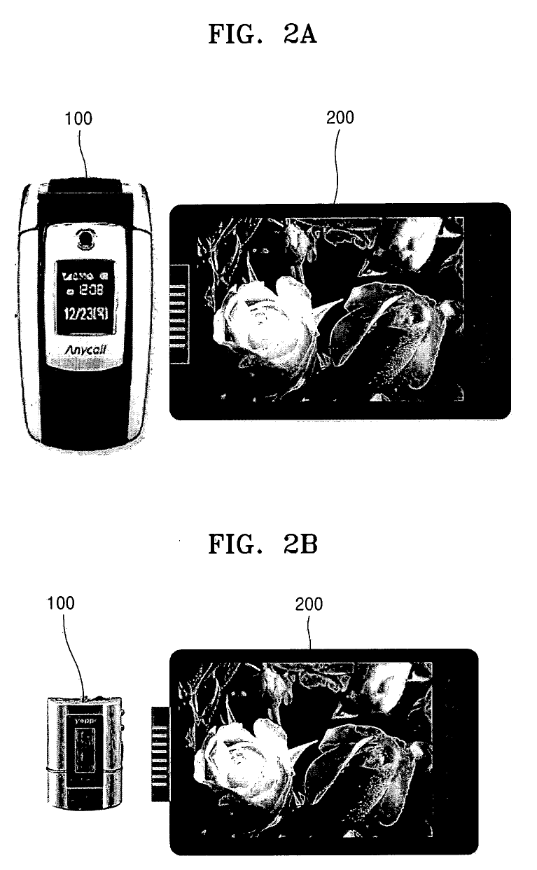

FIG. 2 illustrates exemplary embodiments of mobile display devices matching exemplary types of mobile communication terminals. For example, FIG. 2A illustrates a mobile phone and a corresponding mobile display device, and FIG. 2B illustrates an MP3 player and a corresponding mobile display device. While two embodiments of mobile display devices and two types of mobile communication terminals have been illustrated, it should be understood that other mobile communication terminals may also be provided with embodiments of mobile display devices, which may be similar to the mobile display devices shown, or which may be sized to accommodate a different particular type of mobile communication terminal. As will be further described below, each mobile display device includes a connection unit for connecting to a particular type of mobile communication terminal. It would also be within the scope of these embodiments to provide a connection unit on a mobile display device that is connectable to more than one type of mobile communication terminal.

The mobile communication terminal 100 transmits image data to the mobile display device 200 according to a serial data transmission method. In the serial data transmission method, the image data is sequentially transmitted in units of bits via a transmission line.

The mobile communication terminal 100 also transmits image data to the mobile display device 200 using a differential signaling (“DS”) technology. That is, the mobile communication terminal 100 transmits serial data using the DS technology to provide image data to the mobile display device 200 according to the serial data transmission method.

In particular, the mobile communication terminal 100 may use a low-voltage differential signaling (“LVDS”) standard of the DS technology. The LVDS standard is an interface standard for exchange of data between a computer and a digital display at high speeds.

The LVDS standard has fast bit rates, low power consumption, and excellent noise characteristics, and is thus usable in the fields of high-definition displays, printers, and digital copiers.

According to the LVDS standard, a plurality of parallel bits are serialized into a single data stream to be processed at high speeds, and thus, system costs can be greatly saved since the number of cables or connectors required is less than in a parallel interconnection mode.

The mobile communication terminal 100 transmits image data to the mobile display device 200 by using one of a continuous data transmission method and a discontinuous data transmission method.

In the continuous data transmission method, the image data from the mobile communication terminal 100 is continuously transmitted to the mobile display device 200.

In the discontinuous data transmission method, the previously transmitted image data (still images, photos, or the like) of the image data is not directly transmitted to a display panel. That is, the mobile display device 200 stores the received image data in a memory 220, and then displays the stored image data on a display panel of the mobile display device 200 when no data is transmitted from the mobile communication terminal 100.

The mobile display device 200 includes a connection device, such as a slot-type connection unit, to be inserted into the insertion unit of the mobile communication terminal 100.

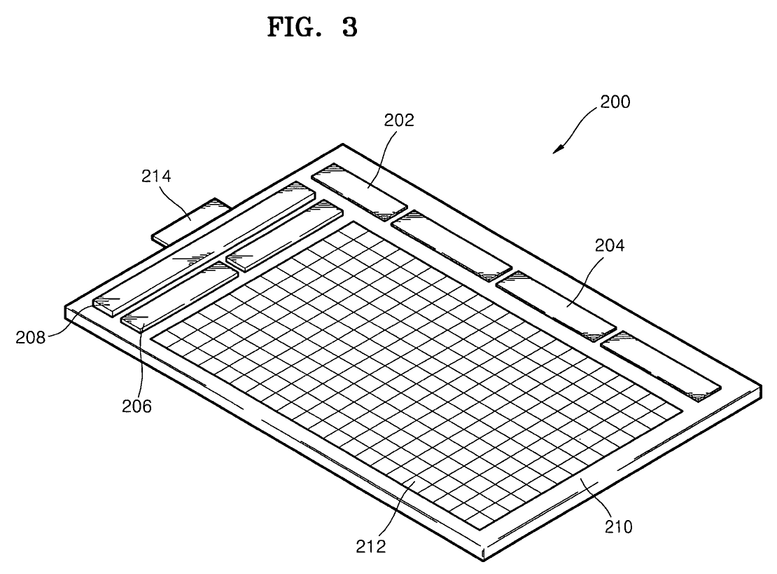

FIG. 3 is a perspective view illustrating an exemplary embodiment of the mobile display device 200, shown in FIG. 1, of an exemplary display system that uses the exemplary mobile communication terminal 100, according to the present invention. Referring to FIG. 3, the mobile display device 200 includes a timing controller 202, a data driver integrated circuit (“IC”) 204, a gate driver IC 206, and a DC-DC converter 208. In particular, the timing controller 202, the data driver IC 204, the gate driver IC 206, and the DC-DC converter 208 are mounted on a display panel 210 of the mobile display device 200 or are installed into the mobile display device 200.

The timing controller 202 performs image data synchronization. The data driver IC 204 for driving a panel, such as display panel 210, of a liquid crystal display (“LCD”), generates driving signals and data, and performs interfacing operations. The gate driver IC 206 generates a scan signal that sequentially selects gate lines. The gate lines and data lines of the display panel 210 may extend in substantially perpendicular directions to deliver signals to each display pixel 212 in a matrix of display pixels 212. The DC-DC converter 208 receives an input DC voltage and outputs a transformed DC voltage.

As illustrated in FIG. 3, the connection unit 214 of the mobile display device 200 is constructed in a serial transmission manner to receive image data transmitted from the mobile communication terminal 100 according to the serial data transmission method. Since the connection unit 214 is constructed in a serial transmission manner, the number of connection terminals of the connection unit 214 to be connected to the mobile communication terminal 100 can be minimized.

In particular, the connection unit 214 according to the current embodiment of the present invention includes eight or fewer pins, and may have 6 or fewer pins, as connection terminals, as will be further described below. The connection unit 214 may extend directly from the mobile display device 200 as shown in FIG. 2B or may be integrally formed within a periphery of the mobile display device 200 as shown in FIG. 2A. In exemplary embodiments, the connection unit 214 may include a portion protruding from a periphery of the mobile display device 200 for providing the connection terminals thereon. The portion may be inflexible for minimizing damage and easing connection to an insertion unit of the mobile communication terminal 100. An opened housing may surround the portion including the connection terminals for further protection. Alternate embodiments of the connection unit 214 and connection devices for connecting the mobile display device 200 to the mobile communication terminal 100 may be included for accommodating varying mobile communication terminals 100.

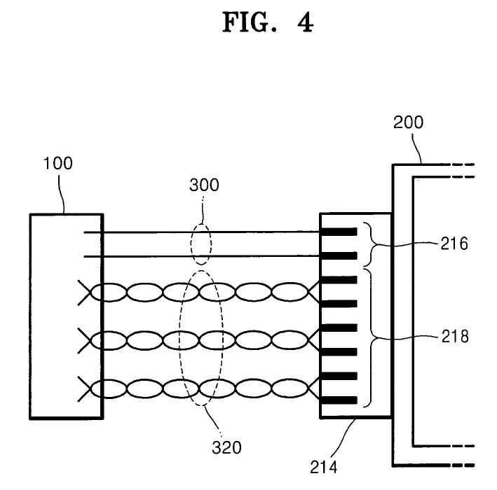

FIG. 4 is a view illustrating an exemplary signal exchange between the mobile communication terminal 100 and the exemplary embodiment of the mobile display device 200 of FIG. 1, according to the present invention. Referring to FIG. 4, the illustrated connection unit 214 of the mobile display device 200 includes a total of eight pins, i.e., two connection terminals 216 connected to power supply lines 300 and six connection terminals 218 connected to differential signal lines 320, although, as described above, an alternate number of terminals would also be within the scope of these embodiments.

The mobile display device 200 includes the memory 220, as shown in FIG. 1, that stores the image data transmitted from the mobile communication terminal 100 according to the discontinuous data transmission method.

The mobile display device 200 reads the image data from the memory 220 and displays, on the display panel 210, the read image data from the memory 220 when no data is transmitted from the mobile communication terminal 100. In particular, even if the mobile display device 200 is separated from the mobile communication terminal 100 and thus cannot receive power therefrom, the mobile display device 200 is capable of temporarily displaying the image data stored in the memory 220.

Even when separated from the mobile communication terminal 100, if the mobile display device 200 includes a unit that stores power supplied from the mobile communication terminal 100, then the mobile display device 200 can display the image data stored in the memory 220, using the stored power.

The mobile display device 200 uses a display panel including, for example, organic light emitting diodes (“OLEDs”) and an LCD.

An OLED includes a self-emissive organic material that emits light without any other source or illumination through electroluminescene (“EL”) when current is supplied to a fluorescent organic compound. The OLED can be driven at a low voltage, be formed to a small thickness, and has a wide viewing angle and a fast response time, thus not leaving an after-image on a display screen.

Also, the quality of an image displayed on a small-sized OLED screen may be the same as or greater than that of an image displayed on an LCD, and the OLED screen can be easily manufactured, thereby saving manufacturing costs. An OLED device can be classified into passive matrix type and active matrix type according to driving methods. In particular, the present invention may use an active matrix type OLED as the mobile display device 200.

An LCD is an electronic device that transforms electric information into visual information, using a variation in the transmissivity of liquid crystal according to an applied voltage, and transmits the visual information. In particular, the present invention may use a thin film transistor (“TFT”)-LCD, which is an active LCD, as the mobile display device 200. The liquid crystal may be disposed between opposing panels containing electrodes which create electric fields there between, thus altering directions of liquid crystal molecules within the liquid crystal and varying the transmissivity of the liquid crystal.

The display panel 210 of the mobile display device 200 may include a plastic plate or a metal plate in order to minimize damage to the mobile display device 200.

An exemplary embodiment of a display system that uses a mobile communication terminal according to the present invention may be embodied as a computer readable recording medium on which a program that executes the exemplary display system is recorded. Also, the exemplary display system that uses the mobile communication terminal according to the present invention may be embodied as computer readable code/instructions/program in a computer readable medium, and realized in a general digital computer that executes the code/instructions/program. The computer readable medium may be any medium, such as, but not limited to, a magnetic storage medium (a ROM, a flash memory, a hard disc, a magnetic tape, etc.), an optical recording medium (a CD-ROM, a DVD, etc.), and a carrier wave that transmits data via the Internet, for example. Also, the present invention may be embodied as a medium (or media) that stores computer readable code, and distributed among and processed by computer systems that are interconnected through a network. The present invention may be stored and implemented as a computer readable code in the distributed system.

In other words, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

Functional programs, code, and code segments that execute the present invention can be easily derived by programmers in the technical field to which the present invention belongs.

Exemplary embodiments of a display system that uses a mobile communication terminal according to the present invention are capable of displaying received content on a display screen larger than a display screen of the mobile communication terminal.

Also, the display system overcomes noise problems and displays high-definition images by utilizing a minimum number of connection terminals that connect a display device to the mobile communication terminal.

Also, the display system minimizes power consumption to reduce power consumption of a mobile communication terminal for image display, and is thereby capable of displaying images for a long time.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A display system which uses a mobile communication terminal, the display system comprising:
the mobile communication terminal having an insertion unit; and
a mobile display device having a slot-type connection unit insertable into the insertion unit of the mobile communication terminal.

2. The display system of claim 1, wherein the connection unit is removable from the insertion unit.

3. The display system of claim 1, wherein the mobile communication terminal transmits image data to the mobile display device according to a serial data transmission method.

4. The display system of claim 3, wherein the connection unit is constructed in a serial transmission manner and receives the image data transmitted according to the serial data transmission method.

5. The display system of claim 4, wherein the connection unit comprises eight or fewer pins as connection terminals to receive the image data.

6. The display system of claim 5, wherein at least one of the pins within the connection unit is connected to a power supply line and a plurality of the pins within the connection unit are connected to signal lines.

7. The display system of claim 1, wherein the mobile communication terminal transmits image data to the mobile display device through differential signaling.

8. The display system of claim 7, wherein the mobile communication terminal transmits image data to the mobile display device using a low-voltage differential signaling standard.

9. The display system of claim 1, wherein the mobile communication terminal transmits image data to the mobile display device according to one of a continuous data transmission method and a discontinuous data transmission method.

10. The display system of claim 9, wherein the mobile display device comprises a memory storing image data transmitted according to the discontinuous data transmission method.

11. The display system of claim 10, wherein the mobile display device reads the image data from the memory and displays read image data.

12. The display system of claim 1, wherein the mobile communication terminal is one of a mobile phone, a personal digital assistant, a digital multimedia broadcasting terminal, and an MPEG audio layer 3 (MP3) player.

13. The display system of claim 1, wherein the mobile display device comprises a timing controller, a data driver integrated circuit, a gate driver integrated circuit, and a DC-DC converter.

14. The display system of claim 13, wherein the timing controller, the data driver integrated circuit, the gate driver integrated circuit, and the DC-DC converter are installed on a display panel of the mobile display device or are installed into the mobile display device.

15. The display system of claim 1, wherein the mobile display device includes a display panel using organic light emitting diodes or liquid crystal.

16. The display system of claim 1, wherein the mobile display device includes a display panel having a plastic plate or a metal plate.

17. The display system of claim 1, wherein the mobile communication terminal provides power to the mobile display device through the connection unit.

18. The display system of claim 17, wherein the mobile display device includes a unit for storing power from the mobile display device.

19. A method of displaying an image from a mobile communication terminal, the method comprising:
transmitting image data from the mobile communication terminal to a mobile display device; and,
displaying the image on a display panel of the mobile display device.

20. The method of claim 19, further comprising inserting a slot-type connection unit of the mobile display device into an insertion unit of the mobile communication terminal prior to transmitting image data, wherein the image data is transmitted through the connection unit.

21. The method of claim 19, wherein transmitting image data includes transmitting image data according to a serial data transmission method.

22. The method of claim 19, further comprising storing received image data in a memory within the mobile display device.

23. The method of claim 22, further comprising displaying image data retrieved from the memory on the display panel of the mobile display device.

24. The method of claim 19, further comprising supplying power from the mobile communication terminal to the mobile display device.

25. The method of claim 24, further comprising storing power from the mobile communication terminal in a unit within the mobile display device.

26. A computer program product for displaying an image from a mobile communication terminal, the computer program product comprising:
a storage medium readable by a processing circuit and storing instructions for execution by the processing circuit for performing a method comprising:
transmitting image data from the mobile communication terminal to a mobile display device; and,
displaying the image on a display panel of the mobile display device.
